(19) United States
(12) Patent Application Publication
(10) Pub. No.: US 2026/0075084 A1
(43) Pub. Date: Mar. 12, 2026

(54) SYSTEMS AND METHODS TO PREVENT DENIAL OF SERVICE ATTACKS FROM GENERATIVE AI VOICE BOTS

(71) Applicant: Pindrop Security, Inc., Atlanta, GA (US)

(72) Inventors: Vijay Balasubramaniyan, Atlanta, GA (US); Amit Gupta, Atlanta, GA (US)

(73) Assignee: Pindrop Security, Inc., Atlanta, GA (US)

(21) Appl. No.: 19/324,843

(22) Filed: Sep. 10, 2025

Related U.S. Application Data
(60) Provisional application No. 63/693,461, filed on Sep. 11, 2024.

(51) Int. Cl. H04L 9/40; G10L 17/02; G10L 17/04; G10L 17/18; G10L 17/26

(52) U.S. Cl. CPC H04L 63/1458; G10L 17/02; G10L 17/04; G10L 17/18; G10L 17/26

(57) ABSTRACT

Embodiments disclosed herein include software processes and of machine-learning architectures for detecting and mitigating against synthetic speech instances. A computer analyzes audio speech data and metadata received with contact events associated with source identifiers. The computer executes machine-learning architecture(s) that determine whether the contact events likely include human-generated speech or machine-generated synthetic speech. The computer may determine the likelihood that contact events represent a DoS attack launched by a source device, by analyzing behavior features in metadata associated with the source identifier. The computer determines whether the contact events originated from the source user device having the source identifier launched a DoS attack and, if so, may update a blocklist. The blocklist may be stored in a database and includes one or more source identifiers that should be rejected or blocked at the current or inbound contact event or at future contact events for the particular source identifiers.

### CROSS-REFERENCE TO RELATED APPLICATION

This application claims the benefit of priority to U.S. Provisional Application No. 63/693,461, filed Sep. 11, 2024, which is incorporated by reference in its entirety.

### TECHNICAL FIELD

This application generally relates to systems and methods for managing, training, and deploying a machine learning architecture for audio processing to detect instances machine-generated synthetic speech and mitigate against further instances of synthetic speech.

### BACKGROUND

With the rise of generative artificial intelligence (AI), it is becoming increasingly more difficult to validate the authenticity of audio and video. The emergence of deepfake attacks, particularly involving synthetic speech directed at enterprise call centers, motivates a need for detecting synthetic speech.

A key concern is the ability of bad actors to leverage generative AI and TTS to automate the creation of these fake voice-based attacks at scale. The emerging threat vector is that bad actors can use AI and text-to-speech (TTS) technology to generate synthetic voice audio signal data and potentially launch large-scale denial of service (DoS) attacks by inundating a target system with automatically generate voice signal data. For instance, a bad actor can write large language model (LLM) prompts that instruct the LLM software to generate scripts and TTS software to generate fake voice signals based on the scripts. The bad actor can target specific individuals like celebrities or political figures or create completely new fake voices. This can overwhelm an interactive voice response (IVR) system with a high volume of fake calls, creating the DoS attack and crowding-out any legitimate traffic. The fake voices and scripts can be generated without targeting specific individuals, making them harder to detect. This could result in significant disruption and loss of service for the targeted organization, such as a bank.

Moreover, recent advancements in generative AI technologies have led to the emergence of “agentic AI” systems capable of autonomously initiating and executing tasks. These agentic AI systems often combine LLMs, speech synthesis engines, and automated task execution frameworks to simulate and launch adaptive human-like interactions. Agentic AI technologies can generate contextually relevant speech, adapt to conversational cues, and perform goal-directed actions with limited direct human oversight. The increasing sophistication of the agentic AI systems can increase the potential for large-scale DoS attacks, where agentic AI systems may be used to generate and transmit high volumes of synthetic audio or video data.

### SUMMARY

Disclosed herein are systems and methods capable of addressing the above-described shortcomings and may also provide any number of additional or alternative benefits and advantages. Embodiments include systems and methods for detecting and mitigating against AI-generated voice audio signals, as automatically generated by computing hardware and software programs, including voice bots and agentic AI systems.

Embodiments may include computing system(s) and computer-implemented method(s) for detecting and mitigating against synthetic speech instances. The embodiments may include a computer comprising at least one processor that performs operations including: obtaining, by a computer, inbound audio signal data associated with a source identifier for one or more contact events. The inbound audio signal data includes an inbound speech audio signal and inbound signal metadata associated with the source identifier. The computer may extract a set of acoustic features using the inbound speech audio signal and a set of signaling data features using the inbound signal metadata associated with the inbound audio signal data. The computer may determine a contact velocity for the source identifier based upon the inbound signal metadata. The contact velocity indicates a contact rate for the one or more contact events of the source identifier. The computer may generate a liveness score for the inbound audio signal indicating a likelihood that the speaker is a human speaker based upon the set of acoustic features and the set of signaling data features. The computer may determine whether the liveness score satisfies a machine-detection threshold. The computer may determine whether the contact velocity satisfies a velocity threshold. In response to determining that the liveness score satisfies a machine-detection threshold and the contact velocity satisfies a velocity threshold, the computer may update a blocklist using the source identifier of the one or more contact events. The blocklist indicates one or more source identifiers to be rejected at a future contact event.

The computer may execute a classifier of a machine-learning architecture trained to determine the inbound speech signal includes human-generated speech or machine-generated speech based upon the liveness score and the machine-detection threshold. The computer may determine a contact volume for the source identifier based upon an amount of the one or more contact events for the source identifier. The computer may identify a denial of service (DoS) attack from the source identifier based upon at least one of the contact velocity or the contact volume. The computer may transmit to a provider server an instruction to reject the inbound audio signal data for the source identifier according to the blocklist.

The computer may identify textual content from the inbound audio speech signal. The computer may generate a plurality of natural language processing (NLP) features based upon the textual content. Each of the plurality of NLP features indicates a degree of a likelihood that the textual content as machine-generated text or other data. The computer may generate an NLP feature indicating the degree of likelihood that the textual content is generated by a large language model (LLM) using a feature extractor of a machine-learning architecture trained on a corpus of human text and machine text.

The source identifier for the one or more contact events includes at least one of a phone number, automated number identifier (ANI), a media access control (MAC) address, an Internet Protocol (IP) address, or a user identifier.

The computer may extract an inbound fakeprint for the inbound audio signal representing a set of spoofing artifacts in the set of acoustic features and the set signaling data features. The computer may execute a fakeprint extractor of a machine-learning architecture on the inbound audio signal to extract the inbound fakeprint.

When updating the blocklist, the computer may store the source identifier in a database record associated with the liveness score generated based on at least one of the inbound fakeprint or the contact velocity.

The computer may detect a behavioral anomaly associated with the source identifier by comparing the contact velocity against a historical contact pattern stored in a database. The behavioral anomaly indicates a deviation from a baseline contact rate for the source identifier.

The computer may generate a notification for display at a graphical user interface, the notification including the liveness score and a detection indicator that the speaker is the human speaker or a machine-generated speaker.

It is to be understood that both the foregoing general description and the following detailed description are exemplary and explanatory and are intended to provide further explanation of the invention as claimed.

### BRIEF DESCRIPTION OF THE DRAWINGS

The present disclosure can be better understood by referring to the following figures. The components in the figures are not necessarily to scale, emphasis instead being placed upon illustrating the principles of the disclosure. In the figures, reference numerals designate corresponding parts throughout the different views.

FIG. 1 is a block diagram showing components of a system for analyzing audio signals during contact events to detect and mitigate against synthetic speech instances, according to an example embodiment.

FIG. 2A and FIG. 2B show dataflow amongst components of a system for speaker verification and authentication, according to an example embodiment.

FIG. 3 shows dataflow amongst components of a system including a machine-learning architecture (e.g., neural network architecture) for identifying a synthetic speech in an audio signal, such as an audio signal during a conversation over a telephone call or any audio call, according to an example embodiment.

FIG. 4 shows a flow diagram of a method of generating liveness scores for speech audio with one or more machine-learning architectures, according to an example embodiment.

FIG. 5 shows dataflow amongst components of a system for passive liveness detection based on extracting and evaluating fakeprint embeddings (sometimes referred to as spoofprints), according to an example embodiment.

FIG. 6 is a flowchart showing operations of a machine-implemented process for detecting and mitigating against synthetic speech instances, according to an example embodiment.

### DETAILED DESCRIPTION

Reference will now be made to the illustrative embodiments illustrated in the drawings, and specific language will be used here to describe the same. It will nevertheless be understood that no limitation of the scope of the invention is thereby intended. Alterations and further modifications of the inventive features illustrated here, and additional applications of the principles of the inventions as illustrated here, which would occur to a person skilled in the relevant art and having possession of this disclosure, are to be considered within the scope of the invention.

Software programs commonly referred to as voice bots have been used to generate synthetic speech audio signals for use in automated contact events. These voice bots typically execute LLMs and TTS engines for scripted and adaptive conversational dialogue to simulate human speech and interactions. In some cases, voice bots may be deployed to initiate high-volume contact campaigns across communications channels, such as telephony, voice-over-IP (VOIP), or messaging platforms. When deployed at scale, voice bots may generate synthetic speech audio signals that overwhelm automated enterprise resources and infrastructure, obstruct legitimate traffic, and degrade the availability of communications services, resulting in a DoS attack.

More recently, certain software programs have emerged that exhibit autonomous behavior and goal-directed tasks and interactions. These programs are sometimes referred to as agentic AI systems. The terms “voice bot” and “agentic AI” may be used interchangeably herein to refer to software programs that generate synthetic speech audio signals and, in some cases, autonomously initiate and manage contact events such that certain voice bots may perform various autonomous functions and interactions. The agentic AI software programming may combine LLMs, speech synthesis software (e.g., TTS engines), and machine-learning models for operating decisions to initiate and manage any number of contemporaneous contact events across any number of communications channels with limited human oversight. Moreover, these agentic AI systems may improve the generated synthetic speech to more closely mimic human conversation cues such as prosody, sentiment, and contextual adaptation, in addition to being used to conduct high-volume contact campaigns that contribute to a DoS attack. In some circumstances, agentic AI systems may generate and transmit synthetic speech audio signals at large scales, creating a form of DoS attack that degrades the availability of communications infrastructure.

As an example, a bad actor may employ an agentic AI system, LLM, and TTS engine to autonomously generate and transmit synthetic or deepfake speech audio signals. The agentic AI system may operate with limited human oversight and is capable of initiating a high-volume contact campaign against an enterprise telephony infrastructure. The agentic AI system generates synthetic speech audio signals that mimic human conversational behavior, including contextual adaptation and emotional tone. When deployed at scale, the agentic AI system could overwhelm interactive voice response (IVR) systems, call center queues, and other components of an enterprise infrastructure. The resulting traffic may crowd out legitimate callers and degrade service availability. Moreover, the synthetic speech audio signals generated by agentic AI systems may be used to impersonate customers, submit fraudulent requests, or bypass authentication operations.

Embodiments described herein address these shortcomings by analyzing inbound audio signal data and metadata associated with contact events to identify acoustic artifacts, behavioral anomalies, and textual patterns indicative of synthetic speech and contact events originating from agentic AI systems. For instance, a computing system may perform various functions described herein for analyzing inbound audio signals and associated metadata to detect synthetic speech audio signals and, further, mitigate DoS attacks launched by automated voice systems, which may be originated or driven by an agentic AI program.

A computer executes any number of machine-learning architectures for analyzing audio speech data and metadata received with one or more contact events associated with a source identifier. The computer executes one or more machine-learning architectures that determine whether the contact events likely include human-generated speech or machine-generate synthetic speech. The computer may further determine the likelihood that the contact events represent a DoS attack launched by a source device on a target system, by extracting and analyzing behavior features in metadata associated with the source identifier. The computer determines whether the one or more contact events originated from the end-user device having the source identifier has launched a DoS attack and, in some implementations, updates a blocklist of source identifiers. The blocklist may be stored in a database and includes one or more source identifiers that should be rejected or blocked at the current or inbound contact event or at future contact events for the particular source identifiers. Non-limiting examples of source identifiers for contact events may include a phone number, automated number identifier (ANI), a media access control (MAC) address, an Internet Protocol (IP) address, or a user identifier, various other types of identifying information or metadata.

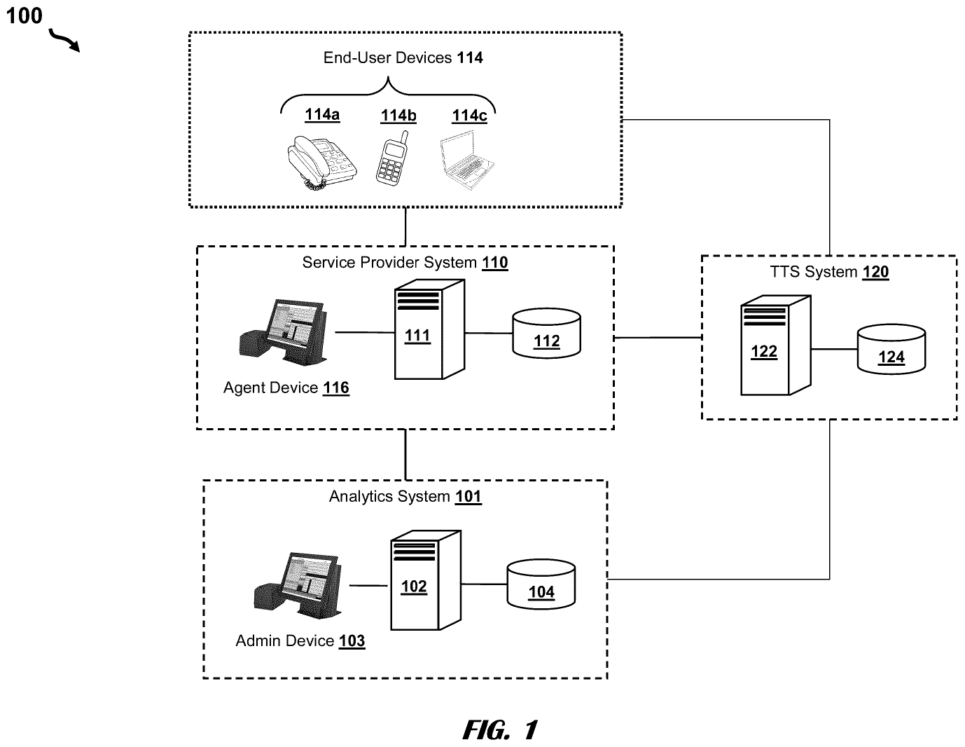

FIG. 1 is a block diagram showing components of a system 100 for analyzing audio signals during contact events to detect and mitigate against synthetic speech instances. The system 100 comprises an analytics system 101, service provider systems 110 of various types of enterprises (e.g., companies, government entities, universities), a text-to-speech (TTS) system 120, and one or more end-user devices 114a-114c, including landline phones 114a, mobile phones 114b, and computing devices 114c (generally referred to as the end-user devices 114 or the end-user device 114). The analytics system 101 includes analytics servers 102, analytics databases 104, and admin devices 103. The service provider system 110 includes provider servers 111, provider databases 112, and agent devices 116. The TTS system 120 includes TTS servers 122 and TTS databases 124.

Embodiments may comprise additional or alternative components or omit certain components from what is shown in FIG. 1, yet still fall within the scope of this disclosure. It may be common, for example, for the system 100 to include multiple provider systems 110 or multiple TTS systems 120, or for the analytics system 101 to have multiple analytics servers 102. It should also be appreciated that embodiments may include or otherwise implement any number of devices capable of performing the various features and tasks described herein. For example, the FIG. 1 shows the analytics server 102 as a distinct computing device from the analytics database 104, though in some embodiments, the analytics database 104 may be integrated into the analytics server 102.

The analytics system 101, the provider system 110, and the TTS system 120 are network system infrastructures 101, 110, 120 comprising physically and/or logically related collections of software and electronic devices managed or operated by various enterprise organizations. The devices of each network system infrastructure 101, 110, 120 are configured to provide the intended services of the particular enterprise organization.

The end-user device 114 initiates and originates a call to the service provider system 110 and transmits the call data to the service provider system 110. The end-user device 114 and components of telephony networks and carrier systems (e.g., switches, trunks) or computing communications networks to perform telephony or networked-communications operations for handling and routing the call data of the new call, including, for example, interpretation, processing, transmission, and routing the call data from the end-user device 114 to the service provider system 110 or the TTS system 120. In some cases, the call data or audio signal data captured by a microphone of the end-user device 114 or generated by the TTS system 120, includes an audio watermark and metadata corresponding to an input speech audio (e.g., synthetic speech, human audio signal).

The end-user device 114 may be any communications or computing device the caller operates to place the telephone call to the call destination (e.g., the service provider system 110). The end-user device 114 may comprise, or be coupled to, a microphone. Non-limiting examples of end-user devices 114 may include landline phones 114a and mobile phones 114b. It should be appreciated that the end-user device 114 is not limited to telecommunications-oriented devices (e.g., telephones). As an example, a calling end-user device 114 may include an electronic device comprising a processor and/or software, such as a computing device 114c or Internet of Things (IoT) device, configured to implement voice-over-IP (VOIP) telecommunications. As another example, the caller computing device 114c may be an electronic IoT device (e.g., voice assistant device, “smart device”) comprising a processor and/or software capable of utilizing telecommunications features of a paired or otherwise networked device, such as a mobile phone 114b.

The various components of the system 100 may be interconnected with each other through hardware and software components of one or more public or private networks. Non-limiting examples of such networks may include: Local Area Network (LAN), Wireless Local Area Network (WLAN), Metropolitan Area Network (MAN), Wide Area Network (WAN), and the Internet. The communication over the network may be performed in accordance with various communication protocols, such as Transmission Control Protocol and Internet Protocol (TCP/IP), User Datagram Protocol (UDP), and IEEE communication protocols. Likewise, the end-user devices 114 may communicate with callees (e.g., service provider systems 110) via telephony and telecommunications protocols, hardware, and software capable of hosting, transporting, and exchanging audio data associated with telephone calls. Non-limiting examples of telecommunications hardware may include switches and trunks, among other additional or alternative hardware used for hosting, routing, or managing telephone calls, circuits, and signaling. Non-limiting examples of software and protocols for telecommunications may include SS7, SIGTRAN, SCTP, ISDN, and DNIS among other additional or alternative software and protocols used for hosting, routing, or managing telephone calls, circuits, and signaling. Components for telecommunications may be organized into or managed by various different entities, such as, for example, carriers, exchanges, and networks, among others.

In the example embodiment of FIG. 1, when the caller places the telephone call to the service provider system 110, the end-user device 114 instructs components of a telecommunication carrier system or network to originate and connect the current telephone call to the service provider system 110. When the inbound telephone call is established between the end-user device 114 and the service provider system 110, a computing device of the service provider system 110, such as a provider server 111 or agent device 116 forwards the observed audio signal (and/or audio data sampled using components in the end-user device 114 from the observed audio signal) received at the microphone of end-user device 114 to the call analytics system 101 via one or more computing networks. The embodiment of FIG. 1 is merely a non-limiting example use for case of understanding and description.

The analytics system 101 may perform various functions related to, for example, evaluating audio signal data and metadata to identify potential DoS attacks and other forms of call risk analysis, among other potential operations. In the example system 100, the analytics system performs the various operations described herein on behalf of the TTS system 120 or the provider system 110, but embodiments are not so limited. For instance, the analytics system 101 may perform the various operations on behalf the end-user device 114 directly or another third-party system, such as a telecommunications carrier or provider system (not shown).

The analytics system 101 is operated by a call analytics service that provides various call management, security, authentication (e.g., speaker verification), and analysis services to customer organizations (e.g., corporate call centers, government entities). Components of the call analytics system 101, such as the analytics server 102, execute various processes using audio data in order to provide various call analytics services to the organizations that are customers of the call analytics service. In operation, a caller uses a caller end-user device 114 to originate a telephone call to the service provider system 110. The microphone of the end-user device 114 observes the caller's speech and generates the audio data represented by the observed audio signal. Alternatively, an end-user accesses TTS software or voice-cloning software (e.g., executed on the end-user device 114 or at the TTS server 122) to generate a machine-generated speech audio signal as a deepfake or clone of genuine, human-generated speech having a particular person's voice. The end-user device 114 or the TTS server 122 then transmits the call audio data including the machine-generated speech to the service provider system 110 or the analytics system 101.

The analytics server 102 executes software programming of a machine-learning architecture having various types of functional engines, implementing certain machine-learning techniques and machine-learning models for analyzing the call audio data, which the analytics server 102 receives from the provider system 110 or the TTS system 120. The machine-learning architecture and/or algorithms of the analytics server 102 analyze the various forms of the call audio data to perform the various risk assessment or caller identification operations, including recognizing speakers and detecting machine-generated speech.

The analytics server 102 of the call analytics system 101 may be any computing device comprising one or more processors and software, and capable of performing the various processes and tasks described herein. The analytics server 102 may host or be in communication with the analytics database 104 and may receive and process the audio data from the one or more service provider systems 110. Although FIG. 1 shows only a single analytics server 102, it should be appreciated that, in some embodiments, the analytics server 102 may include any number of computing devices. In some cases, the computing devices of the analytics server 102 may perform all or sub-parts of the processes and benefits of the analytics server 102. The analytics server 102 may comprise computing devices operating in a distributed or cloud computing configuration and/or in a virtual machine configuration. It should also be appreciated that, in some embodiments, functions of the analytics server 102 may be partly or entirely performed by the computing devices of the service provider system 110 (e.g., the service provider server 111).

In some embodiments, the analytics server 102 generates and evaluates risk scores for authentication operations according to corresponding risk thresholds. The analytics server 102 may generate the risk score based upon various features or feature vector embeddings, as extracted by the analytics server 102 from an audio speech signal associated with a source identifier or metadata of the audio speech signal data, such as signaling metadata (e.g., automated number identifier (ANI), phone number, SIP signaling metadata) or metrics computed by the analytics server 102 (e.g., velocity, volume), among others. The feature vector embeddings include, for example, voiceprints, behaviorprints, deviceprints, or fakeprints, among others.

As an example, the analytics server 102 using signaling metadata to extract or compute a behavior feature as one or more behavioral metrics, based upon one or more contact events associated with the source identifier. The features extracted or computed by the analytics server 102 may include, for example, the various types of data collected from contact data across multiple accounts of the call center system 110, such as behavior data associated with a source of multiple inbound contact events (e.g., velocity or volume with which a phone number is calling into the call center system 110 across all the accounts of the enterprise). If the analytics server 102 determines that the behavior data (e.g., velocity, volume) satisfies a corresponding attack threshold, then the analytics server 102 determines the inbound contact events indicate the end-user device 114 having the source identifier launched a DoS attack using voice bots. In another example, if the analytics server 102 determines that a behaviorprint or other type of data satisfies a similarity score for a known attack feature vector, then the analytics server 102 determines the one or more contact events indicate the end-user device 114 having the source identifier launched the DoS attack using voice bots.

In some instances, the analytics server 102 executes the various audio processing operations of one or more machine-learning architectures described herein for evaluating the permissibility of an operation request. The analytics server 102 executes audio-processing software that includes a neural network (or other forms of machine-learning architectures) that performs speaker recognition and speaker spoof detection, among other potential operations (e.g., speaker verification or authentication, speaker diarization). The machine-learning architecture of the analytics server 102 may, for example, determine whether a particular registered speaker's voice is an inbound speaker's voice within in the inbound audio signal data (e.g., call audio signal; media data file or stream containing an inbound speaker's voice). Additionally or alternatively, the analytics server 102 may determine, for example, the inbound audio signal contains synthetic speech from a TTS server 122 or other source of synthetic speech data of the inbound audio signal.

The neural network architecture operates logically in several operational phases, including a training phase, an enrollment phase, and a deployment phase (sometimes referred to as a test phase or testing). The inputted audio signals processed by the analytics server 102 include training audio signals, enrollment audio signals, and inbound audio signals processed during the deployment phase. The analytics server 102 applies the neural network to each of the types of inputted audio signals during the corresponding operational phase.

The analytics server 102 or other computing device of the system 100 (e.g., call center server 111) can perform various pre-processing operations and/or data augmentation operations on the input audio signals. Non-limiting examples of the pre-processing operations include extracting low-level features from an audio signal, parsing and segmenting the audio signal into frames and segments and performing one or more transformation functions, such as Short-time Fourier Transform (SFT) or Fast Fourier Transform (FFT), among other potential pre-processing operations. Non-limiting examples of augmentation operations include audio clipping, noise augmentation, frequency augmentation, duration augmentation, and the like. The analytics server 102 may perform the pre-processing or data augmentation operations before feeding the input audio signals into input layers of the neural network architecture or the analytics server 102 may execute such operations as part of executing the neural network architecture, where the input layers (or other layers) of the neural network architecture perform these operations. For instance, the neural network architecture may comprise in-network data augmentation layers that perform data augmentation operations on the input audio signals fed into the neural network architecture.

During training, the analytics server 102 receives training audio signals of various lengths and characteristics from one or more corpora, which may be stored in an analytics database 104 or other storage medium. The training audio signals include clean audio signals (sometimes referred to as samples) and simulated audio signals, each of which the analytics server 102 uses to train the neural network to recognize speech occurrences. The clean audio signals are audio samples containing speech in which the speech is identifiable by the analytics server 102. Certain data augmentation operations executed by the analytics server 102 retrieve or generate the simulated audio signals for data augmentation purposes during training or enrollment. The data augmentation operations may generate additional versions or segments of a given training signal containing manipulated features mimicking a particular type of signal degradation or distortion. The analytics server 102 stores the training audio signals into the non-transitory medium of the analytics server 102 and/or the analytics database 104 for future reference or operations of the neural network architecture.

During the training phase and, in some implementations, the enrollment phase, fully connected layers of the neural network architecture generate a training feature vector for each of the many training audio signals and a loss function (e.g., LMCL) determines levels of error for the plurality of training feature vectors. A classification layer of the neural network architecture adjusts weighted values (e.g., hyper-parameters) of the neural network architecture until the outputted training feature vectors converge with predetermined expected feature vectors. When the training phase concludes, the analytics server 102 stores the weighted values and neural network architecture into the non-transitory storage media (e.g., memory, disk) of the analytics server 102. During the enrollment and/or the deployment phases, the analytics server 102 disables one or more layers of the neural network architecture (e.g., fully-connected layers, classification layer) to keep the weighted values fixed.

During the enrollment operational phase, an enrollee, such as an end-consumer of the call center system 110, provides several speech examples to the call analytics system 101. For example, the enrollee could respond to various interactive voice response (IVR) prompts of IVR software executed by a call center server 111. The call center server 111 then forwards the recorded responses containing bona fide enrollment audio signals to the analytics server 102. The analytics server 102 applies the trained neural network architecture to each of the enrollee audio samples and generates corresponding enrollee feature vectors (sometimes called “enrollee embeddings”), though the analytics server 102 disables certain layers, such as layers employed for training the neural network architecture. The analytics server 102 generates an average or otherwise algorithmically combines the enrollee feature vectors and stores the enrollee feature vectors into the analytics database 104 or the call center database 112.

Layers of the neural network architecture are trained to operate as one or more embedding extractors that generate the feature vectors representing certain types of embeddings. The embedding extractors generate the enrollee embeddings during the enrollment phase, and generate inbound embeddings (sometimes called “test embeddings”) during the deployment phase. The embeddings include a spoof or synthetic speech detection embedding (sometimes referred to as a “fakeprint” or “spoofprint”) and a speaker recognition embedding (sometimes referred to as a “voiceprint”). As an example, the neural network architecture generates an enrolled fakeprint and an enrolled voiceprint during the enrollment phase for a registered speaker, and generates an inbound fakeprint and an inbound voiceprint during the deployment phase for an inbound speaker in an inbound audio signal. Different embedding extractors of the neural network architecture generate the fakeprints and the voiceprints, though the same embedding extractor of the neural network architecture may be used to generate the fakeprints and the voiceprints in some embodiments.

As an example, the fakeprint embedding extractor may be a neural network architecture (e.g., ResNet, SyncNet) that processes a first set of features extracted from the input audio signals, where the fakeprint extractor comprises any number of convolutional layers, statistics layers, and fully-connected layers and trained according to the LMCL. The voiceprint embedding extractor may be another neural network architecture (e.g. (e.g., ResNet, SyncNet) that processes a second set of features extracted from the input audio signals, where the voiceprint embedding extractor comprises any number of convolutional layers, statistics layers, and fully-connected layers and trained according to a softmax function.

As a part of the loss function operations, the neural network performs a Linear Discriminant Analysis (LDA) algorithm or similar operation to transform the extracted embeddings to a lower-dimensional and more discriminative subspace. The LDA minimizes the intra-class variance and maximizes the inter-class variance between genuine training audio signals and spoof training audio signals. In some implementations, the neural network architecture may further include an embedding combination layer that performs various operations to algorithmically combine the fakeprint and the voiceprint into a combined embedding (e.g., enrollee combined embedding, inbound combined embedding). The embeddings, however, need not be combined in all embodiments. The loss function operations and LDA, as well as other aspects of the neural network architecture (e.g., scoring layers) are likewise configured to evaluate the combined embeddings, in addition or as an alternative to evaluating separate fakeprint and voiceprints embeddings.

The analytics server 102 executes certain data augmentation operations on the training audio signals and, in some implementations, on the enrollee audio signals. The analytics server 102 may perform different, or otherwise vary, the augmentation operations performed during the training phase and the enrollment phase. Additionally or alternatively, the analytics server 102 may perform different, or otherwise vary, the augmentation operations performed for training the fakeprint embedding extractor and the voiceprint embedding extractor. For example, the server may perform frequency masking (sometimes call frequency augmentation) on the training audio signals for the fakeprint embedding extractor during the training and/or enrollment phase. The server may perform noise augmentation for the voiceprint embedding extractor during the training and/or enrollment phase.

During the deployment phase, the analytics server 102 receives the inbound audio signal of the inbound phone call, as originated from the caller device 114 of an inbound caller. The analytics server 102 applies the neural network on the inbound audio signal to extract the features from the inbound audio and determine whether the caller is an enrollee who is enrolled with the call center system 110 or the analytics system 101. The analytics server 102 applies each of the layers of the neural network, including any in-network augmentation layers, but disables the classification layer. The neural network generates the inbound embeddings (e.g., fakeprint, voiceprint, combined embedding) for the caller and then determines one or more similarity scores indicating the distances between these inbound feature vectors embeddings and the corresponding enrolled feature vectors embeddings. If, for example, the similarity score for the inbound fakeprint(s) satisfies a predetermined machine-generated speech detection threshold, then the analytics server 102 determines that the inbound audio signal likely includes machine-generated speech (e.g., synthetic speech). As another example, if the similarity score for the voiceprints or the combined embeddings satisfies a corresponding predetermined speaker-recognition or detection threshold, then the analytics server 102 determines that the inbound speaker the enrolled registered user are likely the voice of the same person.

Following the deployment phase outputs of the machine-learning architecture, the analytics server 102 (or another device of the system 100) may execute any number of various downstream operations (e.g., speaker authentication, speaker diarization) that employ the determinations produced by the neural network at deployment time, including determining the one or more contact events originated from the end-user device 114 having the source identifier has launched a DoS attack and updating a blocklist of source identifiers. The blocklist may be stored in the analytics database 104 or other database, and includes one or more source identifiers that the provider server 111 or other device of the system 100 should reject or block at the current or inbound contact event or at future contact events for the particular source identifiers.

The TTS server 122 of the TTS system 120 may be any computing device comprising one or more processors and software, and capable of performing the various processes and tasks described herein. The TTS server 122 may host or be in communication with the TTS database 124 and may generate synthetic speech. The TTS server 122 may provide the synthetic speech and information regarding the synthetic speech (e.g., expected watermark signal values, watermark keys, metadata) to the to the user devices 114, provider server 111, or analytics server 102. Although FIG. 1 shows only a single TTS server 122, it should be appreciated that, in some embodiments, the TTS server 122 may include any number of computing devices. In some cases, the computing devices of the TTS server 122 may perform all or sub-parts of the processes and benefits of the TTS server 122. The TTS server 122 may comprise computing devices operating in a distributed or cloud computing configuration and/or in a virtual machine configuration.

In some implementations, the TTS server 122 receives an instruction from the end-user device 114 to generate synthetic speech using a celebrity's voice, which the end-user device 114 may then transmit or upload to the provider server 111. The TTS server 122 or the provider server 111 may transmit an operation request to the analytics server 102, where the operation request includes the synthetic speech based on the celebrity's voice and an indication of the pending or requested voice-sensitive operation (e.g., publish media with the person voice on a website; authenticate the person using voice biometrics authentication).

Turning back to the analytics server 102, the analytics server 102 may generate and transmit the operation response to the provider server 111 or the TTS server 122, or to one or more downstream applications to perform the voice-sensitive operation. The voice-sensitive operation or downstream applications may be executed by the provider server 111, the analytics server 102, the end-user device 114, the admin device 103, the agent device 116, or any other computing device. Non-limiting examples of the voice-sensitive operation or downstream applications may include publishing or uploading media data with the person's voice on a website at the provider server 111, speaker verification (e.g., value or royalty collections), speaker recognition, speech recognition, or voice biometrics, among others.

The service provider system 110 or the TTS system 120 transmits the call data to the analytics system 101 to perform various analytics and downstream audio processing operations. It should be appreciated that analytics servers 102, analytics databases 104, and admin devices 103 may each include or be hosted on any number of computing devices comprising a processor and software and capable of performing various processes described herein.

The service provider system 110 is operated by an enterprise organization (e.g., corporation, government entity) that is a customer of the call analytics system 101. In operation, the service provider system 110 receives the audio data and/or the observed audio signal associated with the telephone call from the end-user device 114. The audio data may be received and forwarded by one or more devices of the service provider system 110 to the call analytics system 101 via one or more networks. For instance, the customer may be a bank that operates the service provider system 110 to handle calls from consumers regarding accounts and product offerings. Being a customer of the call analytics service, the bank's service provider system 110 (e.g., bank's call center) forwards the audio data associated with the inbound calls from consumers to the call analytics system 101, which in turn performs various processes using the audio data, such as analyzing the audio data to detect synthetic speech used to impersonate a customer of the bank, among other voice or audio processing services for risk assessment or speaker identification. It should be appreciated that service provider servers 111, provider databases 112 and agent devices 116 may each include or be hosted on any number of computing devices comprising a processor and software and capable of performing various processes described herein.

The provider server 111 of a service provider system 110 executes software processes for managing a call queue and/or routing calls made to the service provider system 110, which may include routing calls to the appropriate agent devices 116 based on the caller's comments, such as the agent of a call center of the service provider. The provider server 111 can capture, query, or generate various types of information about the call, the caller, and/or the end-user device 114 and forward the information to the agent device 116, where a graphical user interface on the agent device 116 is then displayed to the call center agent containing the various types of information. The provider server 111 also transmits the information about the inbound call to the call analytics system 101 to perform various analytics processes, including the observed audio signal and any other audio data. The provider server 111 may transmit the information and the audio data based upon a preconfigured triggering conditions (e.g., receiving the inbound phone call), instructions or queries received from another device of the system 100 (e.g., agent device 116, admin device 103, analytics server 102), or as part of a batch transmitted at a regular interval or predetermined time.

The provider server 111 executes a call center management and handling software (“call management engine”) for queuing, routing, and/or terminating the inbound calls received at the service provider system 110 from the end-user devices 114 or the TTS server 122. The call management software may route the inbound calls to an agent device 116 or external telephony systems. The call management engine routes the call according to a routing instruction as an input received from, for example, an Interactive Voice Response (IVR) software or server, agent device 116, or analytics server 102, or other computing device or software for generating the routing instruction.

As an example, the provider server 111 (or other device of the service provider system 110) may execute the call management engine and IVR software. The IVR software interacts with the caller to determine which call center agent can handle the caller's requests and identify which agent device 116 of the call center agent to route the inbound call. The IVR software may then generate a routing instruction for the call management engine to route the inbound call to the agent device 116, where the routing instruction includes machine-readable data indicating the agent device 116.

In some embodiments, the routing instruction includes elements of a graphical user interface for display at an agent device 116 indicating information about the inbound call generated by analytics server 102. For instance, the analytics server 102 may determine one or more fraud risk scores and generate a graphical user interface output for the agent device 116 indicating the fraud risk scores and other information about the caller, end-user device 114, and/or other information about the inbound call. The graphical user interface may, for example, display and indicate whether the call center agent at the agent device 116 should continue to field or handle the inbound call, terminate the call, or route the call to another agent device 116. The analytics server 102 may generate the routing instruction for display at the agent device 116 indicating whether the analytics server 102 detected a voice bot that generated machine-generated synthetic speech across the contact event signal data of one or more contact events the inbound call audio signal and metadata, and whether the analytics server 102 determined that source identifier of the end-user device 114 of the contact events launched a DoS attack in the contact events.

In some embodiments, the analytics server 102 may generate a notification for display at a graphical user interface of the agent device 116. The notification may include a liveness score computed by the analytics server 102 based on the inbound audio signal data received from the end-user device 114. The liveness score may indicate a likelihood that the speaker in the inbound audio signal is a human speaker or a machine-generated speaker. The analytics server 102 may further generate a detection indicator based on the liveness score, the detection indicator specifying whether the speaker is classified as human or machine-generated speech. The analytics server 102 may transmit the notification to the agent device 116 for display at the graphical user interface, such that the agent device 116 presents the liveness score and detection indicator to the call center agent. In some implementations, the graphical user interface may include a visual cue, such as a color-coded badge or icon, to indicate the classification result. The call center agent may use the displayed information to determine whether to continue handling the call, escalate the call, or terminate the call.

The analytics database 104 and/or the provider database 112 may contain any number of corpora that are accessible to the analytics server 102 via one or more networks. The analytics server 102 may access a variety of corpora to retrieve clean audio signals, previously received audio signals, recordings of background noise, and acoustic impulse response audio data. The analytics database 104 and/or provider database 112 may contain any number of corpora that are accessible to the analytics server 102 via one or more networks. The analytics database 104 may also query an external database (not shown) to access a third-party corpus of clean audio signals containing speech or any other type of training signals (e.g., example noise). In some implementations, the analytics database 104 and/or the provider database 112 may be queried, referenced, or otherwise used by components (e.g., analytics server 102) of the system 100 to assist with training, configuring, or otherwise establishing operations and functions of the machine-learning architecture of the analytics server 102.

In some embodiments, the analytics database 104 and/or the provider database 112 may store information about end-user devices 114, source identifiers of end-user devices 114, speakers or registered callers as speaker profiles. The analytics database 104 and/or provider database 112 may, for example, contain a blocklist indicating the source identifiers of end-user devices 114 that the analytics server 102 determined launched DoS attacks. The speaker profiles are data files or database records containing, for example, one or more voice operations permissions, audio recordings of prior audio samples (e.g., enrollment speech samples), metadata and signaling data from prior calls (e.g., enrollment data), a trained model or speaker vector (e.g., enrolled voiceprints, enrolled fakeprints) employed by the neural network, and other types of information about the speaker or caller. The analytics server 102 may query the profiles when executing the neural network and/or when executing one or more downstream operations. The speaker profile includes, for instance, the registered feature vector for the registered caller (e.g., enrolled voiceprint), which the analytics server 102 references when determining a similarity score between the enrolled voiceprint feature vector for the registered speaker and the inbound voiceprint feature vector generated for the current or inbound speaker in the inbound audio signal.

The admin device 103 of the call analytics system 101 is a computing device allowing personnel of the call analytics system 101 to perform various administrative tasks or user-prompted analytics operations. The admin device 103 may be any computing device comprising a processor and software, and capable of performing the various tasks and processes described herein. Non-limiting examples of the admin device 103 may include a server, personal computer, laptop computer, tablet computer, or the like. In operation, the user employs the admin device 103 to configure the operations of the various components of the call analytics system 101 or service provider system 110 and to issue queries and instructions to such components.

The agent device 116 of the service provider system 110 may allow agents or other users of the service provider system 110 to configure operations of devices of the service provider system 110. For calls made to the service provider system 110, the agent device 116 receives and displays some or all of the relevant information associated with the call routed from the provider server 111.

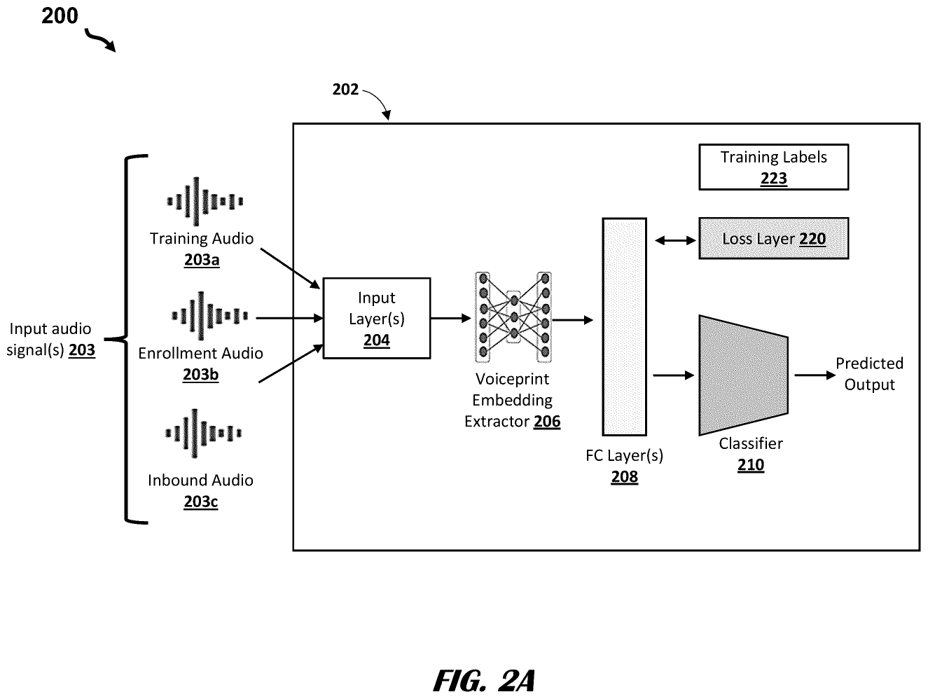

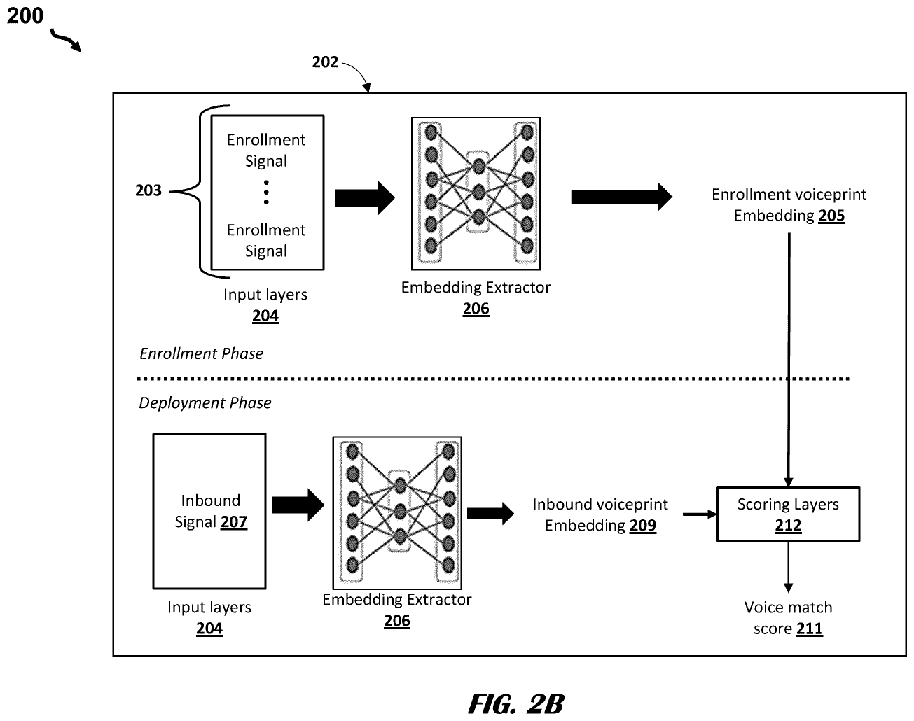

FIGS. 2A-2B show dataflow amongst components of a system 200 for speaker verification and authentication. The system 200 includes a server (e.g., analytics server 102) executing software programming and routines that implement a machine-learning architecture for speaker verification and authentication (referred to as a speaker verifier 202 for case of description and understanding). In the example embodiment of FIGS. 2A-2B, the server executes the speaker verifier 202 during enrollment and deployment (sometimes referred to as “test” phase or “inference time”) operational phases, though the software components of the machine-learning architecture may be executed by any computing device comprising hardware (e.g., processor, non-transitory storage medium) and software components capable of performing operations of the speaker verifier 202, and/or by any number of such computing devices.

The speaker verifier 202 includes or is embodied in software programming that execute various functions, layers, or other aspects (e.g., machine-learning models) of the machine-learning architecture of the speaker verifier 202. In the example system 200, the speaker verifier 202 includes input layers 204 for ingesting audio signals 203, 207 and performing various pre-processing and augmentation operations; layers that define an embedding extractor 206 for extracting features, feature vectors, and speaker embeddings 205, 209; and one or more scoring layers 208 that perform various scoring operations, such as a distance scoring operation, to produce a voice match score 211 or similar types of scores (e.g., authentication score, risk score) or other determinations.

With reference to FIG. 2A, in the training phase, the server feeds the training audio signals 203a into the input layers 204, where the training audio signals 203a may include any number of genuine and fraudulent audio signals, as indicated by training labels 223 associated with the training audio signals 203a. The training audio signals 203a may be raw audio files or pre-processed according to one or more pre-processing operations. The input layers 204 may perform one or more pre-processing operations on the training audio signals 203a. The input layers 204 extract certain features from the training audio signals 203a and perform various pre-processing and/or data augmentation operations on the training audio signals 203a. For instance, input layers 204 execute a transform function to convert the training audio signals 203a from a time-frequency domain to a spectro-temporal representation or convert the training audio signals 203a into multi-dimensional log filter banks (LFBs). The training audio signals 203a are then fed into functional layers defining the embedding extractor 206. The embedding extractor 206 generates predicted feature vectors based on the predicted features fed into the embedding extractor 206, which extracts, for example, a predicted voiceprint embedding based upon the one or more predicted feature vectors.

The machine-learning model(s) of the voiceprint embedding extractor 206 is trained by executing a loss function of a loss layer 220 for tuning the voiceprint extractor 206 according to the training labels 223 associated with the training audio signals 203a. The classifier 210 uses the voiceprint embeddings to determine whether the given input audio signal 203 is, for example, a recognized speaker, genuine, or fraudulent, among others. The loss layer 220 tunes the voiceprint extractor 206 by performing the loss function (e.g., LMCL, PLDA) to determine the distance (e.g., large margin cosine loss) between the predicted classifications, as indicated by supervised training label 223 or previously generated learning clusters. In some embodiments, a user may tune the loss layer 220 (e.g., adjust the m value of the LMCL function) to tune the sensitivity of the loss function. The server feeds the training audio signals 203a into the speaker verifier 202 to re-train and further tune the layers of the speaker verifier 202 and/or tune the voiceprint extractor 206. The server fixes the hyper-parameters of the voiceprint extractor 206 and/or the fully-connected layers 208 when the server determines that the predicted outputs (e.g., classifications, feature vectors, embeddings) converge with the expected outputs, such that a level of error is within a threshold margin of error.

With reference to FIG. 2B, during the optional enrollment phase, the server feeds one or more enrollment audio signals 203b into the embedding extractor 206 to extract an enrollment voiceprint embedding 205 for an enrollee. The embedding extractor 206 produces enrollee embeddings 205 for each of the enrollment audio signals 203b. The voiceprint extractor 206 or other component of the speaker verifier 202 then performs the combination operation on the enrollment feature vectors to extract the enrolled voiceprint 205 for the enrolled user. The enrollment voiceprint embedding 205 is then stored into memory of a database. The server may complete the enrollment phase after generating the enrollment voiceprint embedding 205 based on a threshold number of enrollment audio signals 203b or after updating the enrollment voiceprint embedding 205 using a most recent inbound audio signal 203c received for the enrolled user following a real-world interaction during deployment.

In some embodiments, the server may disable the classifier 210, scoring layers 208, loss layers 220, or other layers of the speaker verifier 202 for the enrollment phase or deployment phase. In some embodiments, the speaker verifier 202 may use the enrollment voiceprint embeddings 205 to further tune the aspects of the speaker verifier 202. The speaker verifier 202 may feed the enrollment voiceprint embeddings 205 into classifier 210 or scoring layers 212, which may include portions of the fully-connected layers 208, to generate a predicated output based on the enrollment audio signal 203b. The loss layers 220 may determine the level error between the predicted outputs of the classifier 210 or scoring layers 212 and the expected outputs based on the inbound audio signal 203c and enrollment voiceprint embedding 205.

During the deployment phase, the input layers 204 may perform the pre-processing operations to prepare an inbound audio signal 203c for the embedding extractor 206. The server, however, may disable the augmentation operations of the input layers 204, such that the embedding extractor 206 evaluates the features of the inbound audio signal 203c as received. The embedding extractor 206 comprises one or more layers of the machine-learning architecture trained (during a training phase) to detect speech and/or generate feature vectors based on the features extracted from the audio signals 203c, which the embedding extractor 206 outputs as inbound voiceprint embeddings 209. The embedding extractor 206 generates the inbound feature vector for the inbound audio signal 203c based on the features extracted from the inbound audio signal 203c. The embedding extractor 206 outputs this feature vector as an inbound voiceprint 209 for the inbound audio signal 203c.

The speaker verifier 202 feeds the enrolled voiceprint 205 and the inbound voiceprint 209 to the scoring layers 212 to perform various scoring operations. The scoring layers 212 perform a distance scoring operation that determines the distance (e.g., similarities, differences) between the enrolled voiceprint 205 and the inbound voiceprint 209, indicating the likelihood that the inbound voiceprint 209 is fraudulent. For instance, a lower distance score for the inbound voiceprint 209 indicates the inbound voiceprint 209 is more likely to be a presentation attack. The speaker verifier 202 may output a voice match score 211 (S_{V}), which may be a value generated by the scoring layers 212 based on one or more scoring operations (e.g., distance scoring). The scoring layers 212 or other component of the speaker verifier 202 determine whether the distance score or other outputted values satisfy threshold values.

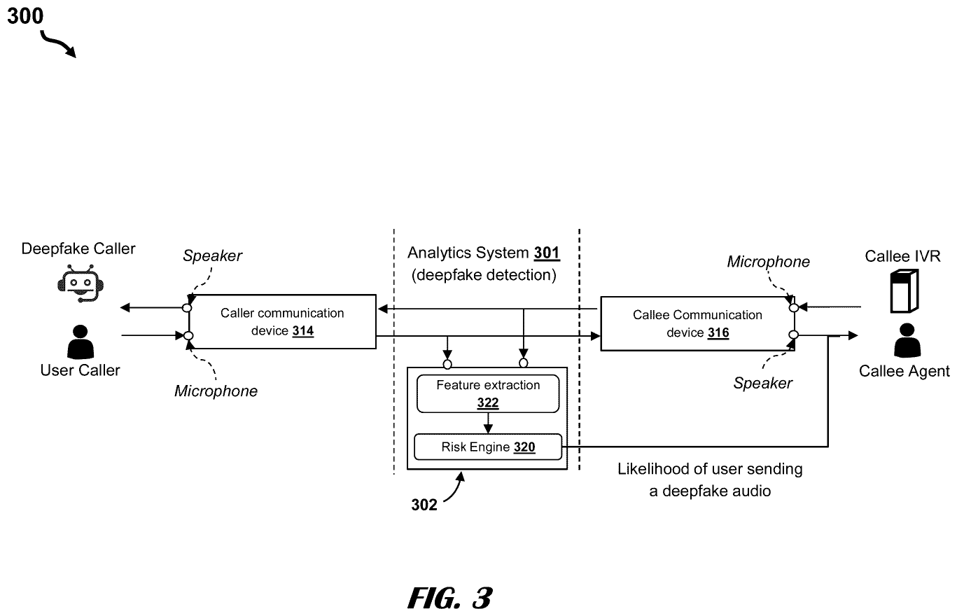

FIG. 3 shows dataflow amongst components of a system 300 including a machine-learning architecture (e.g., neural network architecture) for identifying a synthetic speech in an audio signal, such as an audio signal during a conversation over a telephone call or any audio call. The system 300 may include an analytics system 301 having an analytics server 302, a caller communication device 314, and callee communication device 316, among others. The analytics server 302 may include software programming that performs functions of a feature extractor 322 and a risk engine 320, among others.

The caller communication device 314 may be any communications or computing device (e.g., similar to the caller device 114) to be used to place a call to a call destination (e.g., the callee communication device 316). In some circumstances, the user of the caller communication device 314 may be a person or an entity (sometimes herein referred to as a caller) that initiates interaction with the callee communication device 316 through an audio-based communication protocol that captures and sends audio signals, which may contain instances or utterances of the caller's voice. Additionally or alternatively, in some circumstances, the user includes a device or computing system generating deepfake audio. Oftentimes, no data, other than the call data containing the audible voice signals, is provided to the analytics system 301 from the user or from an intermediate call center (e.g., call center system 110 and call center server 111).

The callee communication device 316 may be any communications or computing device that receives the audio data from the caller device 314 and handles the inbound call. The callee device 316 includes hardware and software components for automated call-handling, such as a callee IVR system, or for presenting certain call data to a callee-agent user of the callee, such as devices of callee agents. For instance, the callee device(s) 316 includes computing device (e.g., call center server 111) executing software functions of a callee IVR system that captures call data and inputs from the caller device 314 and routes the call according to inputs from the caller device 314. Additionally or alternatively, the callee device(s) 316 includes a computing device (e.g., similar to the agent device 116) operated by a user of the callee (e.g., callee-agent of the call center system 110), which presents the call data to the callee-agent and provides the audio data to the callee-agent. The call may be received and handled by more than one callee device 316. For instance, the call may be received and handled by a callee device 316 operating as the IVR system, programmed to the call to the callee-agents according to selection inputs received from the caller device 314. The intent of the (deepfake caller) user at the caller communication device 314 would be to convince the receiver-callee (e.g., callee IVR, callee agent) at the callee communication device 316 that the callee is receiving call data or in a conversation with a user caller who is a live human.

The analytics system 301 may be one or more computing devices to process data associated with the call between the caller communication device 314 and the callee communication device 316. Upon receipt of the call, the callee communication device 316 may forward the data to the analytics system 301 for further analysis. In some embodiments, the analytics system 301 may be an intermediary between the caller communication device 314 and the callee communication device 316 with visibility to the call with the caller communication device 314 and the callee communication device 316. The analytics server 302 in the analytics system 301 may be any computing device executing software components of a deepfake detection system (DDS) to analyze and evaluate the call. The DDS applies various software programming operations on the call data (e.g., call metadata, audio signal data) that determines the likelihood of the caller being a deepfake audio caller and/or likelihood of the caller being a human user caller.

The feature extractor 322 executing on the analytics server 302 includes software programming that, for example, generates or extracts a set of features from audio data of the call between the caller communication device 314 and the callee communication device 316. The software features of the feature extractor 322 includes various functional aspects (e.g., executable functions, machine-learning layers, machine-learning models) of one or more machine-learning architectures for performing the various functions of the feature extractor 322 described herein. The features may refer to any data (e.g., acoustic parameters, NLP features, sentiment analysis, speech patterns, or timestamps) derived from the call. When the user on the caller communication device 314 initiates a call, the caller and the caller device 314 is connected to the callee device 316. The audio or other types of call data from the call may be sent to the analytics system 301. The feature extractor 322 may detect speech from the audio (e.g., using a voice activity detection (VAD) program) and extract, for example, temporal features or emotional features. In some cases, the VAD program or feature extractor 322 (or other software component of the server 302) performs functions for generating a text-based audio transcription file of the call audio. The server 302 applies the feature extractor 322 on the transcription, and the feature extractor 322 (or other machine-learning architecture) is trained to extract NLP features from the audio transcription file.

The risk engine 320 executing on the analytics server 302 includes software programming that, for example, calculates or determines a risk score indicating a likelihood that the caller at the caller communication device 314 is a human user or a deepfake caller, based on the set of extracted features. The extracted features may be then sent to the risk engine 320. The software programming of the risk engine 320 includes various functional aspects (e.g., executable functions, machine-learning layers, machine-learning models) of one or more machine-learning architectures for performing the various functions of the risk engine 320 described herein, such as analyzing and calculating the risk score using one or more machine learning models and machine-learning techniques. The risk engine 320 may compare the risk score against a risk threshold and/or other threshold scores (e.g., liveness score, fraud score). In some implementations, the analytics server 302 transmits the outputs of the risk engine 320 to the callee device 316, and the callee device 316 handles the call using the outputs of the risk engine 320. For instance, the callee device 316 includes a graphical user interface that presents the output score(s) to the callee-agent, and the callee-agent indicates whether the callee device 316 (or other device of the system 300) should drop the call or take another action. In some implementations, the analytics server 302 sends instructions to the callee device 316 for automatically handling the call. For instance, the callee device 316 includes the callee IVR software preconfigured to automatically handle the call (e.g., route the call to the callee-agent device, drop the call) according to instructions or other outputs received from the analytics system 301.

The models in the DDS of the analytics system 301 can be trained using a variety of techniques, such as supervised learning or unsupervised learning, and can be further refined and optimized over time to improve its accuracy and effectiveness. Additionally, the DDS system can be integrated with other security measures, such as multi-factor authentication or fraud analytics, to provide a more comprehensive and robust security solution for call centers. One or more servers or other computing devices may function as analytics servers executing software programming and functions of the DDS.

The feature extractor 322 may extract various types of features from the call data of a user's response to a prompt or question and extract relevant information, which the risk engine 320 references and analyzes to determine whether the response was produced by a human user caller or a deepfake caller.

The analytics server 302 may also extract transcribed text content from the audio. The analytics server 302 may perform data acquisition of the text from audio transcription algorithms to turn audio to texts for analysis. With the acquisition, the analytics server 302 may pre-process the text data by conducting text cleaning such as removing stop words, stemming the words, and converting the text to lower case, among others.

The analytics server 302 may execute programming of NLP operations and techniques on the extracted and processed text to analyze the text associated with the audio signal data, in connection with detecting the voice bots or synthetic speech. In some embodiments, the analytics server 302 may perform authorship verification to identify if the text in the deepfake has been written by the same person as the original speaker. The authorship verification can be used to identify whether the text has been generated by a machine learning model or has been written by a human. In some embodiments, the analytics server 302 may perform contextual analysis to analyze the context of the text. Machine-generated speech may be upon a script text that is out of context or not consistent with the topic being discussed. Also, machine-generated may contain text that is not grammatically correct or consistent with the style and tone of the original speaker. Contextual analysis can be used to identify such discrepancies.

In some embodiments, the analytics server 302 may execute classification models and functions for classifying speech as human and or machine-generated synthetic speech (e.g., deepfakes). The analytics server 302 trains these classification models on a large training dataset of a corpus containing human composed text and deepfake engine generated text. The analytics server 302 may execute software programming for generating transcripts or scripts of portions of the speech audio signal. A feature extractor or classification model may extract an embedding from the text and classifies into one of the one or more classes, such as likely machine-generated text (e.g., LLM-generated text, voice bot-generated text). In some embodiments, the analytics server 302 may perform emotion recognition using sentiment analysis on the transcribed data. The analytics server 302 may use various machine learning algorithms to classify the transcribed data into different emotional categories, such as happy, sad, angry, and neutral. The analytics server 302 may also analyze the intensity and duration of the emotions expressed in the text and speech to identify any discrepancies between the original and synthetic content.

The NLP features and functions above can be used in combination with audio analysis to create a more comprehensive deepfake detection system executed by the analytics server 302. The combination of multiple techniques can help to improve the accuracy of deepfake detection. From the NLP-text perspective, deepfake TTS functions raise a few issues and capitalize on organic human-to-human conversational cues that deepfake audio and deepfake texts often do not include. For example, humans often use interjections or stop words (e.g., “hmmm,” “umm,” “well”) with a pause as an interjection to indicate they are thinking or processing what the other person is saying. Stop words can also indicate uncertainty or a need for further clarification. However, deepfake texts do not typically use, for example, “hmmm” as deepfake texts (or deepfake speech used to generate the deepfake text) do not need to indicate thought processes. Instead, the deepfakes may use pre-recorded phrases or responses to show they are processing the input. As another example, a human caller can quickly understand context of a conversation and adjust the human caller's (human-to-human) conversational responses accordingly. The human caller can recognize and address subtle cues, such as sarcasm, humor, or frustration, and respond appropriately (and organically). A robot caller (machine-generated text or machine-generated speaker), on the other hand, often struggles to understand the context and can sometimes misinterpret the meaning of what the called-human is saying.

Using the NLP analysis and classifying operations, the analytics server 302 may determine whether the transcribed text of the inbound audio signal indicates that the script and corresponding inbound audio signal likely originated from a human or a voice bot software executed at an end-user device.

In some embodiments, the analytics server 302 may use empirical analysis. Human responses may be more versatile in vocabulary than robot callers' responses. The analytics server 302 may compute and analyze a metric called “density,” which is a measurement indicating, for example, how crowded different words are used in a text. The word density may be calculated using: D=100×V/(L×N), where N is the number of answers, an average length (L) is the average number of words in each answer, and a vocab size (V) is the number of unique words used in all answers. The word density of humans may be much greater than machine-generated texts in every split, which indicates that humans use a more diverse vocabulary in their expressions. The analytics server 302 may use the density to determine the likelihood of whether the caller is human or machine.

In some embodiments, the analytics server 302 may use a statistical analysis. Factual structures may also be a discriminative factor between machine-generated and human-written text. This is because machines often lack the ability to understand the underlying meaning of the text and the context in which the text is presented. As a result, machine-generated text often lacks coherent and logical factual structures. Overall, while robots can simulate human language to some extent, robots lack the naturalness and flexibility of human communication. As a result, the way robot callers use words (e.g., vocabulary, structure, diction) can differ significantly from human callers. The analytics server 302 may determine various statistics from the text, and may calculate the risk score.

The analytics server 302 may generate the transcripts from calls with the contact center. These call transcripts may have a typical ratio of repeat phrases spoken by the agent in reply to the human caller (“repeated similar utterances/overall utterances”). For a caller using Text-to-Speech (TTS) software, leveraging machine-generated text, the repeated phrases spoken by the agent are higher than typically seen. This happens because the caller may encounter prompts from the agent that are unexpected and the caller has difficulty in fully understanding the context, requiring the Agent to repeat the Agent's prompting questions or phrases to the caller, as shown in the sample call transcript below:
Caller: “Calling regarding unblocking the last credit card transaction.” [Caller is assuming the call has been authenticated in the IVR]
Agent: “Sure, can you tell me your name?” [Agent is expecting to verify the identification of the caller]
Caller: “Can you unblock the last credit card transactions please?” [in the Caller's TTS software produced this statement as a response to an unexpected prompt and misunderstood context from the Agent to the Caller's TTS software]
Agent: “Can you please tell me your name before answering your query?” [The Agent is re-asking the question to verify the Caller's identification again]
Caller: “John Doe.” [Caller's TTS software finally understands and catches up with the context].

The analytics server 302 may use the NLP-based context similarity technique to compare and determine a repetitious utterance ratio of “repeated similar utterances” over “overall utterances.” The analytics server 302 may compare the ratio for the current call against the repetitious utterance ratio of a typical call from a human. The analytics server 302 can use this comparison to detect a likelihood that the caller is using deepfakes, generated from a caller device having TTS software leveraging machine-generated text.

In some embodiments, the machine-learning architectures of the analytics server 302 may detect mismatched responses based on the call phase (IVR or Agent). During a typical call to a contact center, the caller, using a caller device having a TTS program leveraging machine-generated text, may not realize that the call has switched from an IVR leg call of the call to an agent leg of the call, after initial identification or may not realize that the call has been sent to the IVR again (e.g., to enter sensitive information such as social security number (SSN) or personal identification number (PIN)). As a result, the caller device 314 may continue sending dual-tone multi-frequency signaling (DTMF) tones to the IVR of the callee device 316 when the agent expects to talk or vice-versa. As such, the detection of voice during a (non-voice enabled) IVR leg or detection of DTMF tones during the agent leg of the call may imply a high likelihood of a deepfake caller in the form of the TTS system leveraging machine-generated text at the caller device.

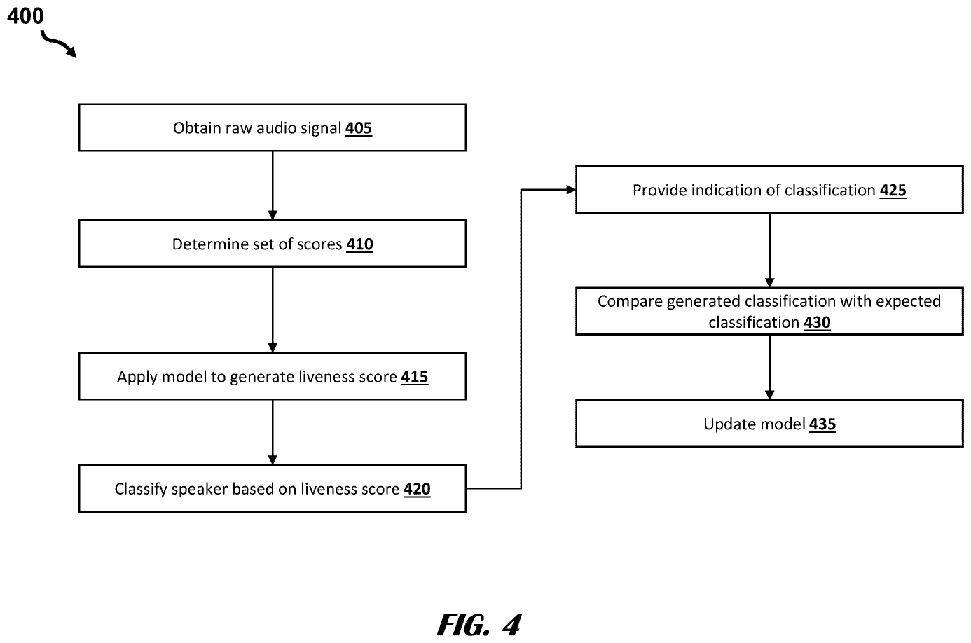

FIG. 4 shows a flow diagram of a method 400 of generating liveness scores for speech audio with one or more machine-learning architectures. The method 400 may be performed or implemented using any of the components detailed herein, such as the service provider system 110 or the analytics system 101, among others. Under the method 400, at step 405, a computer may retrieve, identify, or otherwise obtain a raw audio signal. The raw audio signal may be from a calling device (e.g., the end-user device 114 or the caller communication device 214) including at least one speech signal for a speaker (e.g., the caller on the calling device). The speech signal may be acquired from the speaker, in a passive manner without any prompts (e.g., from the computer). For example, the computer may obtain the raw audio signal from audio data corresponding to a conversation between the caller and an agent on an agent device (e.g., the agent on the agent device 116, the callee agent on the callee communication device 216, or the IVR program). In some embodiments, the speech signal may be acquired from the speaker, in an active manner. For instance, the computer may obtain the raw audio signal from the audio data corresponding to an answer from the caller in response to a prompt provided by the computer or the agent device.

In some embodiments, the computer may retrieve or identify a training dataset used to train a machine learning (ML) model to generate liveness scores. The training dataset may identify or include a set of examples. Each example of the training dataset may identify or include a sample raw audio signal and a label indicating one of machine or human for the associated sample raw audio signal. From each example in the training dataset, the computer may identify the sample audio signal to train the ML model. The sample raw audio signal may include a speech signal from a calling device with a human caller or machine synthesizer. The labels may have been previously generated by an agent or another user examining the speech signal.

At step 410, the computer may calculate, generate, or otherwise determine a set of scores based on the raw audio signal. The set of scores may be used to determine whether the speaker (e.g., the caller) in the speech signal of the raw audio signal. The set of scores may identify or include at least one first score identifying a change in the background of the speech signal; at least one second score identifying a passive liveness of the speech speaker in the speaker; and at least one third score identifying a degree of repetition of speech within the speech signal of the speaker, among others. In some embodiments, the computer may determine each score based on a set of acoustic features extracted from the speech signal of the raw audio signal.

In determining the set of scores, the computer may determine, identify, or otherwise extract a set of features from one or more portions of the raw audio signal. The set of features may include any number of features derived from the raw audio signal to use in determining whether the caller in the set of audio speech signals is a human or machine. The portions may include the speech signal from the speaker, the background, and instances of repeated audible prompts, among others. To extract, the computer may apply a machine learning (ML) model, artificial intelligence (AI) algorithm, or other functions of the machine-learning architecture to each portion of the raw audio signal. In some embodiments, the computer may apply an automated speech recognition (ASR) algorithm to the raw audio signal to extract textual content. The textual content may include or contain text in chronological sequence of strings corresponding to speech from the caller or the agent, or both.

In some embodiments, the computer may apply a feature extractor to the portion of the raw audio signal to generate or determine a set of acoustic parameters. The set of acoustic parameters may be, for example, Geneva Minimalistic Acoustic Parameter Set (GeMAPS) low-level descriptor features, such as: frequency related parameters, amplitude related parameters, and spectral parameters, among others. In some embodiments, the computer may apply the ML model or algorithm to the raw audio signal to generate or determine a speech pattern of the caller. The speech pattern may identify or include, for example: a sentiment, prosody (e.g., melody or rhythm of speech), pitch, volume, or speech rate, among others, of the caller.

In extracting the set of features from the raw audio signal, the computer may determine the set of scores. Using the set of features from the background, the computer may identify or determine the first score identifying the change in the background of the speech signal. For example, the computer may determine a rate of change or lack of change in the background across one or more segments of the raw audio signal. Based on the set of features from the speech signal of the speaker, the computer may determine the score identifying a passive liveness of the speech speaker in the speaker. For instance, the computer may use the speech patterns to determine a degree of liveness of the speaker in the speech signal. From the set of features from the instances of repeated audible prompts (or other repetition), the computer may determine the score identifying a degree of repetition of speech within the speech signal of the speaker. For example, the computer may compare the set of acoustic features across multiple segments of the audio signal to determine the score indicating the degree of similarity for the score.

In some embodiments, the computer may retrieve historical contact data associated with the source identifier from a database, such as the analytics database or provider database. The historical contact data may include a baseline contact velocity or volume computed from prior contact events associated with the source identifier. The computer may compare the contact velocity of the current contact event to the baseline or historic pattern of contact velocity to detect a behavioral anomaly. A behavioral anomaly may include a deviation from the historical contact pattern, such as a sudden increase in contact frequency, irregular timing of contact events, or a burst pattern inconsistent with prior behavior. The computer may generate a behavioral anomaly indicator based on the comparison, and may use the behavioral anomaly indicator as an input to a fraud classifier or as a standalone signal for updating a blocklist or triggering a rejection instruction.

At step 415, the computer may apply the ML model of the machine-learning architecture to the set of scores to calculate, determine, or otherwise generate at least one liveness score. The liveness score may identify or indicate a likelihood that the speaker in the raw audio signal is human (or conversely a machine). Using the ML model, the computer may combine, join, or otherwise aggregate the set of scores to generate the liveness score. In some embodiments, the ML model may identify, define, or otherwise a set of weights corresponding to the set of scores. Each weight of the weights may specify, identify, or otherwise define a value to which to bias or factor the respective score. To apply, the computer may feed or input the set of scores in the ML models to process the set of scores. In accordance with the set of weights defined by the ML model, the computer may generate a weighted combination (e.g., a weighted sum or average) of the set of scores as the liveness score.

In some embodiments, the ML model of the machine-learning architecture may include a neural network (e.g., a deep learning neural network) with a set of parameters arranged across a set of layers. In applying, the computer may input or feed the set of scores into the neural network. Upon feeding, the computer may process the set of scores in accordance with the set of parameters arranged across the set of layers in the neural network of the machine-learning architecture. From processing of the input set of scores, the computer may generate the liveness score. In some embodiments, the machine-learning architecture may include the ML model for the fakeprint extractor and the spoof classifier. In some embodiments, the machine-learning architectures may implement the ML models, techniques, or functions used to generate the liveness score, such as an SVM, a clustering algorithm (e.g., K-nearest neighbors), a regression model (e.g., a linear or logistic regression), or PCA, among others.

At step 420, the computer may determine, identify, or otherwise classify the speaker as one of human or machine based on the liveness score. To classify, the computer may compare the liveness score with a threshold. The threshold may delineate, identify, or otherwise define a value for the liveness score at which to classify the speaker of one of human or machine. Generally, the higher the value of the liveness score, the more likely the speaker in the raw audio signal may be a human speaker. Conversely, the lower the value of the liveness score, the less likely the speaker in the raw audio signal may be a human speaker. If the liveness score satisfies (e.g., greater than or equal to) the threshold, the computer may classify the speaker as a human speaker. On the other hand, if the liveness scores does not satisfy (e.g., less than) the threshold, the computer may classify the speaker as machine-generated (e.g., voice bot).

In some embodiments, the threshold may be fixed at a value predetermined for distinguishing between the machine or human. In some embodiments, the computer may calculate, generate, or otherwise determine at least one threshold to compare against the liveness score. The determination of the threshold by the computer may be based on feedback data. The feedback data may be received via a user input on an interface (e.g., a graphical user interface) on an agent computer (e.g., the agent device 116 or the callee communication device 216). The feedback may indicate or identify a value to define the threshold. Using the feedback, the computer may assign or set the value identified in the feedback to threshold to compare against the liveness score.

The computer may determine the threshold to compare against the liveness score based on a training dataset. As discussed herein, the training dataset may include a set of examples, each of which may identify or include a sample raw audio signal and a label indicating one of machine or human for the associated sample raw audio signal. During training the ML model, the computer may adjust or update the threshold based on loss metrics. Each loss metric may identify a degree of deviation between the classification output using the liveness score from the ML model versus the label indicating the expected classification of the speaker from the training dataset. The computer may also set the threshold based on modifications of the ML model. In some embodiments, the training dataset may be acquired or derived from historical data (e.g., logs of calls between callers and agents on a database).

At step 425, the computer may send, transmit, or otherwise provide an indication of the classification of the speaker as one of human or machine. The classification may identify whether the speaker in the speech signal of the audio signal as one of the genuine human speaker or machine. When the speaker is classified as human speaker, the computer may generate the indication to identify the speaker as the human speaker. Conversely, when the speaker is classified as the machine, the computer may generate the indication to identify the caller as the machine. The computer may provide the indication to an agent computer (e.g., the agent device 116 or the callee communication device 216) for presentation that to the agent. Once received, the agent computer may display, render, or otherwise present that indication of the caller as one of fraudulent or human to the agent via an interface (e.g., a graphical user interface (GUI)).

Optionally, at step 430, the computer may compare the classification generated using the liveness score from the ML model with an expected classification. The expected classification may be from feedback or the training dataset. In some embodiments, the computer may compare the generated classification with feedback. The feedback may be received via a user input on an interface (e.g., a graphical user interface) on another computer (e.g., the agent computer). The feedback may include or identify an expected classification (e.g., as indicated by the agent computer) indicating the speaker in the raw audio signal as one of human or machine. With the receipt, the computer may compare the expected classification identified in the feedback with the generated classification.

In some embodiments, the computer may retrieve or identify a corresponding label from the training dataset for the raw audio signal inputted into the ML model. In each example of the training dataset, the label may identify or include the expected classification indicating the speaker in the sample raw audio signal as one of human or machine. With the receipt, the computer may compare the expected classification identified in the label with the classification generated using the ML model. The computer may traverse through the examples to identify the corresponding example, as the computer applies the associated sample raw audio from the example to the ML model.

Based on the comparison between the generated classification and the expected classification, the computer may calculate, generate, or otherwise determine at least one loss metric. The loss metric may be determined by the computer according to a loss function, such as a mean squared error, a mean absolute error, a cross-entropy loss, or a Huber loss function, among others. The loss metric may indicate or identify a degree of deviation between the classification generated by the liveness score from the ML model versus the expected classification.

Optionally, at step 435, the computer may modify, retrain, or otherwise update the ML model based on the comparison between the generated classification and the expected classification. In some embodiments, the computer may update or retraining the ML model using the loss metric determined from the comparison. The updating or retraining may be in accordance with an optimization function, such as an implicit stochastic gradient descent (SGD), a momentum, adaptive gradient algorithm, root mean square propagation, and adaptive moment estimation (ADAM), among others.

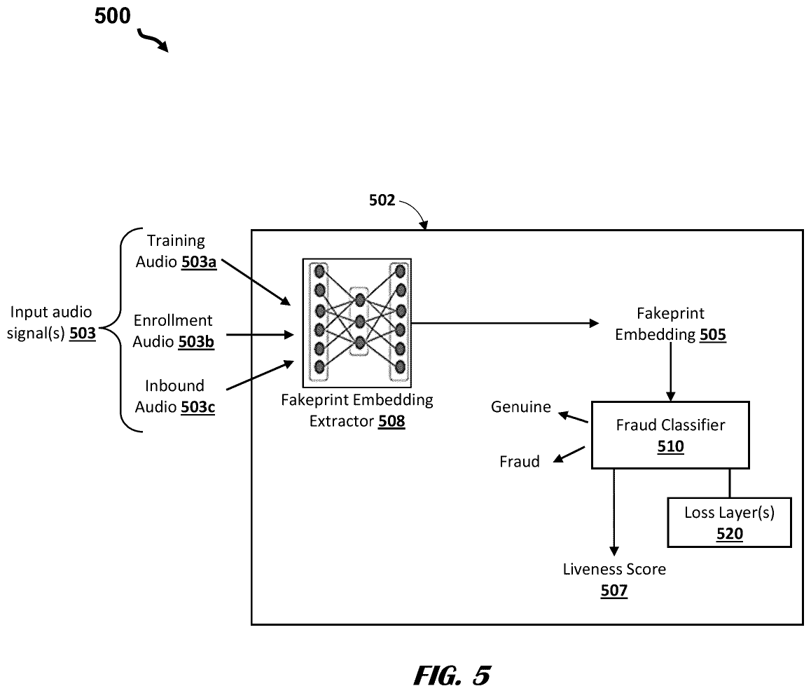

FIG. 5 shows dataflow amongst components of a system 500 for passive liveness detection based on extracting and evaluating fakeprint embeddings 505 (sometimes referred to as spoofprints). The system 500 includes a server (e.g., analytics server 102) executing software programming and routines that implement a machine-learning architecture for liveness detection (referred to as a passive liveness detector 502 for case of description and understanding). In the example embodiment of FIG. 5, the server executes the passive liveness detector 502, though the software components of the machine-learning architecture may be executed by any computing device comprising hardware (e.g., processor, non-transitory storage medium) and software components capable of performing operations of the passive liveness detector 502, and/or by any number of such computing devices. The passive liveness detector 502 ingests input audio signals 503a-503c (generally referred to as input audio signals 503), extracts one or more features related to, or indicative, of fraud artifacts and a fakeprint vector embedding (fakeprint 505), and executes the fraud classifier 510 or other scoring layers of the fraud classifier 510 to generate a liveness score 507.

The passive liveness detector 502 includes or is embodied in software programming that execute various functions, layers, or other aspects (e.g., machine-learning models) of the machine-learning architecture of the passive liveness detector 502. At the frontend of the machine-learning architecture in the passive liveness detector 502, the passive liveness detector 502 includes layers that define, for example, input layers (not shown), speech recognizers, and/or a feature extractor for extracting features from input audio signals 503; layers that define a fakeprint embedding extractor (fakeprint extractor 508) for extracting the features and/or fakeprint feature vector embeddings (fakeprints 505) using the various types of features extracted from the input audio signal 503. As a backend, the passive liveness detector 502 includes machine-learning layers including functions and machine-learning models of a spoof classifier 510 or other types of scoring layers, which perform various classifier or scoring operations, such as a distance scoring operation, to produce and evaluate a passive liveness score 507 that indicates the likelihood that the input audio signal 503 contains fraudulent speech signals associated with a presentation attack, or similar types of scores (e.g., authentication score, risk score) or other determinations.

The passive liveness detector 502 obtains the input audio signal 503 according to the corresponding operational phase of the machine-learning architecture. During a training phase, the passive liveness detector 502 receives or retrieves training audio signals 503a from one or more corpora of training signals stored in one or more databases (e.g., analytics server 102, provider database 112). During an optional enrollment phase, the passive liveness detector 502 receives or retrieves enrollment audio signals 503b known to include instances of an enrolled speaker's voice or known to include instances of one or more types of fraud, such as an enrollment audio signal 503b known to contain a deepfake of utterances of a person or spoofed metadata of a device, among others. In the training or enrollment phase, the passive liveness detector 502 or other software component of the server may generate simulated instances of the training audio signals 503a or enrollment audio signals 503d using one or more types of data augmentation operations that manipulate the audio features or metadata of a “clean” or “genuine” training audio signal or enrollment audio signal. During the deployment phase, the passive liveness detector 502 receives an inbound audio signal 503a from a user device (e.g., end-user device 114).

In the training phase, the server feeds the training audio signals 503a into the input layers 204, where the training audio signals 503a may include any number of genuine and fraudulent speech signals, as indicated by training labels (not shown) associated with the training audio signals 503a. The training audio signals 503a may be raw audio files or pre-processed according to one or more pre-processing operations of input layers. The input layers may perform one or more pre-processing operations on the training audio signals 503a. The input layers extract certain features from the training audio signals 503a and perform various pre-processing and/or data augmentation operations on the training audio signals 503a. For instance, input layers execute a transform function to convert the training audio signals 503a from a time-frequency domain to a spectro-temporal representation or convert the training audio signals 503a into multi-dimensional log filter banks (LFBs). The training audio signals 503a are then fed into functional layers defining the fakeprint embedding extractor (or fakeprint extractor 508). The fakeprint extractor 508 generates predicted fakeprint feature vectors based on the predicted features fed into the fakeprint extractor 508, which extracts, for example, a predicted fakeprint 505 based upon the one or more predicted feature vectors.

The machine-learning model(s) of the fakeprint extractor 508 is trained by executing a loss function of a loss layer 220 for tuning the voiceprint extractor 206 according to the training labels 223 associated with the training audio signals 503a. The classifier 510 uses the fakeprints 505 to determine whether the given input audio signal 503 is, for example, a genuine or fraudulent. The loss layer 520 tunes the fakeprint extractor 508 by performing the loss function (e.g., LMCL, PLDA) to determine the distance (e.g., large margin cosine loss) between the predicted classifications, as indicated by supervised training labels or previously generated learning clusters. In some embodiments, a user may tune the loss layer 520 (e.g., adjust the m value of the LMCL function) to tune the sensitivity of the loss function. The server feeds the training audio signals 503a into the passive liveness detector 502 to re-train and further tune the layers of the passive liveness detector 502 (e.g., adjust scoring layers of the fraud classifier 510) and/or tune the fakeprint extractor 508. The server fixes the hyper-parameters of the fakeprint extractor 508 and/or the fully-connected layers of the fakeprint extractor 508 or the fraud classifier 510 when the server determines that the predicted outputs (e.g., classifications, feature vectors, embeddings) converge with the expected outputs, such that a level of error is within a threshold margin of error.

In some embodiments, the server may disable the classifier 510, scoring layers, loss layers 520, or other layers of the passive liveness detector 502 for the enrollment phase or deployment phase. In some embodiments, the passive liveness detector 502 may use the enrollment fakeprint 505 to further tune the aspects of the passive liveness detector 502. The passive liveness detector 502 may feed the fakeprint 505 into the fraud classifier 510 or scoring layers, which may include portions of the fully-connected layers and/or the fraud classifier 510, to generate a predicated output based on the enrollment audio signal 503b. The loss layers 520 may determine the level error between the predicted outputs of the fraud classifier 510 or scoring layers and the expected outputs based on the inbound audio signal 503c and enrolled fakeprint 505.

During the deployment phase, the input layers may perform the pre-processing operations to prepare an inbound audio signal 503c for the fakeprint extractor 508. The server, however, may disable the augmentation operations of the input layers, such that the fakeprint extractor 508 evaluates the features of the inbound audio signal 503c as received. The fakeprint extractor 508 comprises one or more layers of the machine-learning architecture trained (during a training phase) to detect speech and/or generate feature vectors based on the features tailored to detect fraud artifacts and extracted from the audio signals 503c. Using the features extracted from the input audio signal 503, the fakeprint extractor 508 extracts and outputs an inbound fakeprint 505 as mathematical representation of fraud artifacts in the input audio signal 503.

The passive liveness detector 502 feeds the inbound fakeprint 505 to the fraud classifier 510 or scoring layers to perform various scoring operations. The scoring layers and/or the fraud classifier 510 perform a distance scoring operation that determines the distance (e.g., similarities, differences) between the inbound fakeprint 505 and a centroid or feature vector previously generated as fraud-detection cluster using the training fakeprints 505 extracted from the training audio signal 503a. The passive liveness score 507 indicates the likelihood that the input audio signal 503 is fraudulent. The passive liveness score 507 may be a value generated by the scoring layers and/or fraud classifier 510 based on one or more scoring operations (e.g., distance scoring). For instance, the scoring layers or other component of the passive liveness detector 502 determine whether the distance score or other outputted values satisfy threshold values.

In some embodiments, the passive liveness detector 502 or the fraud classifier 510 may access historical contact data stored in a database to identify and detect behavioral anomalies. The passive liveness detector 502 may retrieve a historical contact pattern for a source identifier, the historical contact pattern indicating a baseline or historic contact velocity or volume associated with prior contact events of the source identifier. The fraud classifier 510 may compare the contact velocity of the current contact event to the historical contact pattern to detect a behavioral anomaly. A behavioral anomaly may include a deviation from the baseline contact rate, such as a sudden increase in contact frequency or volume. The fraud classifier 510 may generate a behavioral anomaly indicator based on the comparison, and the fraud classifier 510 may incorporate the behavioral anomaly indicator into the liveness score or classification output (or other types of potential outputs). In some implementations, the behavioral anomaly indicator may be used independently of the fakeprint or liveness score to update a blocklist or trigger a rejection instruction.

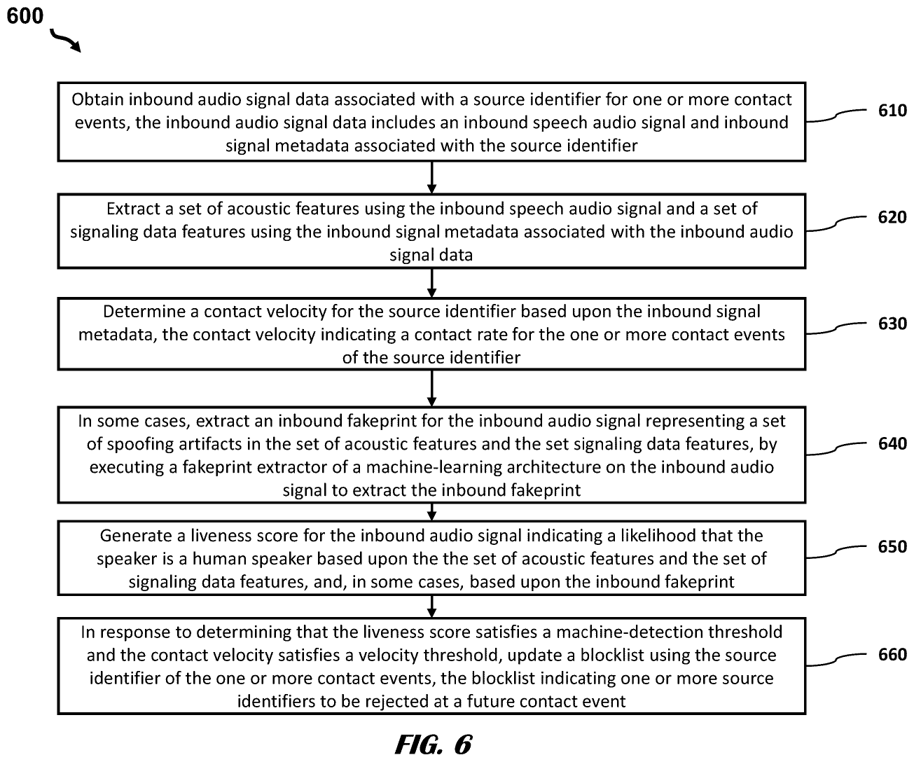

FIG. 6 is a flowchart showing operations of a machine-implemented process 600 for detecting and mitigating against synthetic speech instances. Embodiments may include additional, fewer, or different operations than those described in the process 600. The process 600 is performed by a server executing machine-readable software code associated with the machine-learning architecture, though any number of computing devices and processors may perform the various operations described here.

At operation 610, the server obtains inbound audio signal data associated with a source identifier for one or more contact events. The inbound audio signal data includes an inbound speech audio signal and inbound signal metadata associated with the source identifier. At operation 620, the server extracts a set of acoustic features using the inbound speech audio signal and a set of signaling data features using the inbound signal metadata associated with the inbound audio signal data.

At operation 630, the server determines a contact velocity for the source identifier based upon the inbound signal metadata. The contact velocity indicates a contact rate for the one or more contact events of the source identifier. In some embodiments, at operation 640, the server extracts an inbound fakeprint for the inbound audio signal representing a set of spoofing artifacts in the set of acoustic features and the set signaling data features. The server may execute a fakeprint extractor of a machine-learning architecture on the inbound audio signal to extract the inbound fakeprint. At operation 650, the server generates a liveness score for the inbound audio signal indicating a likelihood that the speaker is a human speaker based upon the set of acoustic features and the set of signaling data features. In some embodiments, the server extracts the inbound fakeprint for the inbound audio signal representing the set of spoofing artifacts in the set of acoustic features and the set signaling data features (as in operation 640), and generates the liveness score for the inbound audio signal indicating the likelihood that the speaker is a human speaker or machine-generated speaker based upon the inbound fakeprint, in addition or as an alternative to other types of acoustic features or signaling data features, such as the context velocity or volume.

At operation 660, the server may determine whether the liveness score satisfies a machine-detection threshold. The server may also determine whether the contact velocity satisfies a velocity threshold. In response to the server determining that the liveness score satisfies a machine-detection threshold and the contact velocity satisfies a velocity threshold, the server updates a blocklist using the source identifier of the one or more contact events, the blocklist indicating one or more source identifiers to be rejected at a future contact event.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

Embodiments implemented in computer software may be implemented in software, firmware, middleware, microcode, hardware description languages, or any combination thereof. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, attributes, or memory contents. Information, arguments, attributes, data, etc. may be passed, forwarded, or transmitted via any suitable means including memory sharing, message passing, token passing, network transmission, etc.

The actual software code or specialized control hardware used to implement these systems and methods is not limiting of the invention. Thus, the operation and behavior of the systems and methods were described without reference to the specific software code being understood that software and control hardware can be designed to implement the systems and methods based on the description herein.

When implemented in software, the functions may be stored as one or more instructions or code on a non-transitory computer-readable or processor-readable storage medium. The steps of a method or algorithm disclosed herein may be embodied in a processor-executable software module which may reside on a computer-readable or processor-readable storage medium. A non-transitory computer-readable or processor-readable media includes both computer storage media and tangible storage media that facilitate transfer of a computer program from one place to another. A non-transitory processor-readable storage media may be any available media that may be accessed by a computer. By way of example, and not limitation, such non-transitory processor-readable media may comprise RAM, ROM, EEPROM, CD-ROM or other optical disk storage, magnetic disk storage or other magnetic storage devices, or any other tangible storage medium that may be used to store desired program code in the form of instructions or data structures and that may be accessed by a computer or processor. Disk and disc, as used herein, include compact disc (CD), laser disc, optical disc, digital versatile disc (DVD), floppy disk, and Blu-Ray disc where disks usually reproduce data magnetically, while discs reproduce data optically with lasers. Combinations of the above should also be included within the scope of computer-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

While various aspects and embodiments have been disclosed, other aspects and embodiments are contemplated. The various aspects and embodiments disclosed are for purposes of illustration and are not intended to be limiting, with the true scope and spirit being indicated by the following claims.

What is claimed is:

1. A computer-implemented method for detecting and mitigating against synthetic speech instances, the method comprising:
obtaining, by a computer, inbound audio signal data associated with a source identifier for one or more contact events, the inbound audio signal data includes an inbound speech audio signal and inbound signal metadata associated with the source identifier;
extracting, by the computer, a set of acoustic features using the inbound speech audio signal and a set of signaling data features using the inbound signal metadata associated with the inbound audio signal data;
determining, by the computer, a contact velocity for the source identifier based upon the inbound signal metadata, the contact velocity indicating a contact rate for the one or more contact events of the source identifier;
generating, by the computer, a liveness score for the inbound audio signal indicating a likelihood that a speaker is a human speaker based upon the set of acoustic features and the set of signaling data features; and
in response to determining that the liveness score satisfies a machine-detection threshold and the contact velocity satisfies a velocity threshold, updating, by the computer, a blocklist using the source identifier of the one or more contact events, the blocklist indicating one or more source identifiers to be rejected at a future contact event.

2. The method of claim 1, wherein the computer executes a classifier of a machine-learning architecture trained to determine the inbound speech signal includes human-generated speech or machine-generated speech based upon the liveness score and the machine-detection threshold.

3. The method of claim 1, further comprising determining, by the computer, a contact volume for the source identifier based upon an amount of the one or more contact events for the source identifier.

4. The method of claim 3, further comprising identifying, by the computer, a denial of service (DoS) attack from the source identifier based upon at least one of the contact velocity or the contact volume.

5. The method of claim 1, further comprising transmitting, by the computer, to a provider server an instruction to reject the inbound audio signal data for the source identifier according to the blocklist.

6. The method of claim 1, wherein determining the liveness score includes:
identifying, by the computer, textual content from the inbound audio speech signal;
generating, by the computer, a plurality of natural language processing (NLP) features based upon the textual content, each of the plurality of NLP features indicating a degree of a likelihood that the textual content as machine-generated; and
generating, by the computer, an NLP feature indicating the degree of likelihood that the textual content is generated by a large language model (LLM) using a feature extractor of a machine-learning architecture trained on a corpus of human text and machine text.

7. The method of claim 1, wherein the source identifier for the one or more contact events includes at least one of a phone number, automated number identifier (ANI), a media access control (MAC) address, an Internet Protocol (IP) address, or a user identifier.

8. The method of claim 1, further comprising extracting, by the computer, an inbound fakeprint for the inbound audio signal representing a set of spoofing artifacts in the set of acoustic features and the set signaling data features, by executing a fakeprint extractor of a machine-learning architecture on the inbound audio signal to extract the inbound fakeprint,
wherein the liveness score for the inbound audio signal indicating a likelihood that a speaker is a human speaker based upon the inbound fakeprint.

9. The method of claim 8, wherein updating the blocklist includes storing, by the computer, the source identifier in a database record associated with the liveness score generated based on at least one of the inbound fakeprint or the contact velocity.

10. The method of claim 1, further comprising detecting, by the computer, a behavioral anomaly associated with the source identifier by comparing the contact velocity against a historical contact pattern stored in a database, wherein the behavioral anomaly indicates a deviation from a baseline contact rate for the source identifier.

11. A system for detecting and mitigating against synthetic speech instances, the system comprising:
a computer comprising at least one processor configured to:
obtain inbound audio signal data associated with a source identifier for one or more contact events, the inbound audio signal data includes an inbound speech audio signal and inbound signal metadata associated with the source identifier;
extract a set of acoustic features using the inbound speech audio signal and a set of signaling data features using the inbound signal metadata associated with the inbound audio signal data;
determine a contact velocity for the source identifier based upon the inbound signal metadata, the contact velocity indicating a contact rate for the one or more contact events of the source identifier;
generate a liveness score for the inbound audio signal indicating a likelihood that a speaker is a human speaker based upon the set of acoustic features and the set of signaling data features; and
in response to determining that the liveness score satisfies a machine-detection threshold and the contact velocity satisfies a velocity threshold, update a blocklist using the source identifier of the one or more contact events, the blocklist indicating one or more source identifiers to be rejected at a future contact event.

12. The system of claim 11, wherein the computer executes a classifier of a machine-learning architecture trained to determine the inbound speech signal includes human-generated speech or machine-generated speech based upon the liveness score and the machine-detection threshold.

13. The system according to claim 11, wherein the computer is further configured to determine a contact volume for the source identifier based upon an amount of the one or more contact events for the source identifier.

14. The system of claim 13, wherein the computer is further configured to identify a denial of service (DoS) attack from the source identifier based upon at least one of the contact velocity or the contact volume.

15. The system according to claim 11, wherein the computer is further configured to transmitting, by the computer, to a provider server an instruction to reject the inbound audio signal data for the source identifier according to the blocklist.

16. The system of claim 11, wherein the computer is further configured to, when determining the liveness score:
identify textual content from the inbound audio speech signal;
generate a plurality of natural language processing (NLP) features based upon the textual content, each of the plurality of NLP features indicating a degree of a likelihood that the textual content as machine-generated; and
generate an NLP feature indicating the degree of likelihood that the textual content is generated by a large language model (LLM) using a feature extractor of a machine-learning architecture trained on a corpus of human text and machine text.

17. The system of claim 11, wherein the source identifier for the one or more contact events includes at least one of a phone number, automated number identifier (ANI), a media access control (MAC) address, an Internet Protocol (IP) address, or a user identifier.

18. The system of claim 11, wherein the computer is further configured to detect a behavioral anomaly associated with the source identifier by comparing the contact velocity against a historical contact pattern stored in a database, wherein the behavioral anomaly indicates a deviation from a prior contact rate for the source identifier.

19. The system of claim 11, wherein the computer is further configured to extract an inbound fakeprint for the inbound audio signal representing a set of spoofing artifacts in the set of acoustic features and the set signaling data features, by executing a fakeprint extractor of a machine-learning architecture on the inbound audio signal to extract the inbound fakeprint,
wherein the liveness score for the inbound audio signal indicating a likelihood that a speaker is a human speaker based upon the inbound fakeprint.

20. The system of claim 19, wherein when updating the blocklist the computer is further configured to store the source identifier in a database record associated with the liveness score generated based on at least one of the inbound fakeprint or the contact velocity.
